(19) United States
(12) Patent Application Publication
(10) Pub. No.: US 2007/0071927 A1
(43) Pub. Date: Mar. 29, 2007

(54) Tubular member

(75) Inventors: Futoshi Nishikawa, Higashikurume-shi (JP); Nobuaki Takamatsu, Higashimurayama-shi (JP); Hidenori Kosai, Niiza-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: DAIWA SEIKO, INC., Tokyo (JP)

(21) Appl. No.: 11/529,674

(22) Filed: Sep. 28, 2006

(30) Foreign Application Priority Data
Sep. 29, 2005 (JP) 2005-283569
Sep. 30, 2005 (JP) 2005-288210

(51) Int. Cl. B29C 70/08

(52) U.S. Cl. 428/36.3; 428/36.9

(57) ABSTRACT

A tubular member is disclosed which achieves reduced weight, prevention of unevenness or chips in decoration, and good decoration quality. This tubular member is formed as follows a fiber reinforced prepreg in which reinforcing fibers are impregnated with a synthetic resin is wound to form a main body of the tubular member, and decorative particles are embedded into an outer surface side resin of the fiber reinforced prepreg disposed on an outermost side of the main body. An average thickness of the outer surface side resin layer of the fiber reinforced prepreg on the outermost side is formed to be smaller than an average diameter of the reinforcing fibers of this fiber reinforced prepreg on the outermost side, and an average thickness of decorative particles is formed to be equal to or less than the average thickness of the outer surface side resin layer.

### CROSS-REFERENCE TO RELATED APPLICATIONS

This application is based upon and claims the benefit of priority from prior Japanese Patent Applications No. 2005-283569, filed Sep. 29, 2005; and No. 2005-288210, filed Sep. 30, 2005, the entire contents of both of which are incorporated herein by reference.

### BACKGROUND OF THE INVENTION

1. Field of the Invention

The present invention relates to a tubular member, and more particularly, it relates to a tubular member having a main body formed by winding it with a fiber reinforced prepreg which includes reinforcing fibers impregnated with a synthetic resin.

2. Description of the Related Art

A fishing rod formed of a tubular member has heretofore been known, wherein the tubular member is formed by winding a fiber reinforced prepreg, and a paint is applied to an outer peripheral surface thereof.

As known in, for example, Jpn. Pat. Appln. KOKAI Publication No. 6-86616 (Pat. Publication No. 3178626,) in the tubular member formed by winding the fiber reinforced prepreg, the paint is previously applied to a part corresponding to the outer peripheral surface of the tubular member in the prepreg forming an outermost layer, and a shaping tape is wound on the wound prepreg previously painted and forming the outermost layer, and then these are cured, thereby forming a rod material. In this previously applied paint, a pigment with a laminated structure is mixed into a transparent resin, and the pigment is oriented to cause regular multiple reflection in a fixed direction in this transparent resin.

Furthermore, a tubular member has been developed as in Jpn. Pat. Appln. KOKAI Publication No. 2004-229610, wherein a fiber reinforced prepreg is wound to form a crude tube, and decorative particles are disposed on a surface part of a fiber reinforced resin layer located in an outermost layer of the crude tube, and then a shaping tape is bonded thereto for heating and curing.

However, when the paint is previously applied to the part corresponding to the outer peripheral surface of the rod in the prepreg forming the outermost layer, the paint is applied onto the surface of the unhardened prepreg, so that the weight of the paint is increased. Moreover, the prepreg is wound on a mandrel in a situation where cohesion properties in the paint and the prepreg are not lost, which results in a poor workability.

Furthermore, when the decorative particles are disposed on the surface part of a fiber reinforced resin layer located in the outermost layer of the tube material, the decorative particles drop or the decorative particles move during the bonding of the shaping tape if the decorative particles are insufficiently fixed in the surface part of the fiber reinforced resin layer, which can cause a defect in appearance such as unevenness or chips.

### BRIEF SUMMARY OF THE INVENTION

The present invention has been made under such circumstances, and is directed to provide a tubular member which achieves reduced weight, prevention of unevenness or chips in decoration, and good decoration quality.

In order to achieve the above-mentioned object, according to one aspect of the present invention, there is provided a tubular member comprising a tubular main body formed by being wound with at least a piece of fiber reinforced prepreg, the fiber reinforced prepreg being formed by a large number of reinforcing fibers having an average diameter impregnated with a synthetic resin, the main body having an outer surface side resin layer made of the synthetic resin, wherein

the outer surface side resin layer has an average thickness;

the outer surface side resin layer further includes a large number of decorative particles embedded therein;

the large number of decorative particles have an average thickness;

the average thickness of the outer surface side resin layer is smaller than the average diameter of the reinforcing fibers; and

the average thickness of the decorative particles is smaller than the average thickness of the outer surface side resin layer.

According to this tubular member, the decorative particles are reliably held in the outer surface side resin of the fiber reinforced prepreg disposed on an outermost side of the main body, so that the drop of the decorative particles can be prevented. Moreover, the decorative particles are held into the extremely thin resin on the outer surface side of the fiber reinforced prepreg. Thus, a tubular member is formed which has extremely light weight and high decoration effects.

Furthermore, according to another aspect of the present invention, there is provided a tubular member comprising:

a tubular main body formed by being wound with at least a piece of fiber reinforced prepreg, the fiber reinforced prepreg being formed by a large number of reinforcement fibers having an average diameter impregnated with a synthetic resin, the main body having an outer surface side resin layer made of the synthetic resin;

a large number of decorative particles disposed in the outer surface side resin layer, each of the decorative particles having a thickness and an outer surface which is not covered with the outer surface side resin layer; and

a resin film formed on the outer surface of the decorative particles and having a thickness smaller than the thickness of the decorative particles,

wherein the outer surface side resin layer is exposed between the adjacent decorative particles.

According to this tubular member, the resin film having a thickness smaller than the thickness of the decorative particles is formed on the outer surface of the decorative particles, and the outer surface side resin layer is exposed between the decorative particles, so that the tubular member has lighter weight and high decoration effects. Moreover, since the resin film is formed on the outer surface of the decorative particles, the close contacting property of the decorative particles is improved.

According to still another aspect of the present invention, there is provided a method of manufacturing a tubular member, comprising the steps of:

winding, around a core member, a fiber reinforced prepreg in which reinforcing fibers are impregnated with a synthetic resin, to form a tubular main body;

mixing decorative particles covered with a resin into a solvent, blowing the solvent onto an outer surface of the main body, and vaporizing the solvent in order to attach the decorative particles to the outer surface of the main body;

covering the outer surface of the main body with a cover member to cure the main body; and

removing the core member and the cover member from the main body.

### BRIEF DESCRIPTION OF THE SEVERAL VIEWS OF THE DRAWING

FIG. 1 is a schematic diagram showing a tubular member according to a preferred embodiment of the present invention;

FIG. 2 is an explanatory diagram showing a part of a step of manufacturing the tubular member in FIG. 1;

FIG. 3 is a sectional view in which a part of a main body of the tubular member in FIG. 1 is enlarged;

FIG. 4 is a sectional view in which a part of an outer layer forming the main body of the tubular member in FIG. 1 is enlarged;

FIG. 5 is a schematic diagram showing the state of arrangement of decorative particles on a surface side of the outer layer of the tubular member in FIG. 1;

FIG. 6 is a schematic diagram showing another state of arrangement of the decorative particles similar to those in FIG. 5;

FIG. 7 is an explanatory diagram illustrating an appearance produced by the decorative particles by spreading an outer surface of the tubular member in FIG. 1 into a planar shape;

FIG. 8 is an enlarged sectional view illustrating the decorative particle;

FIG. 9 is a sectional view similar to FIG. 3 showing a main body of a tubular member according to another embodiment;

FIG. 10 is a sectional view similar to FIG. 4 enlarging a part of FIG. 9;

FIG. 11 is a further enlarged sectional view similar to FIG. 5;

FIG. 12 is an explanatory diagram similar to FIG. 7 illustrating an appearance produced by the decorative particles;

FIG. 13 is a sectional view, similar to FIG. 4, of a tubular member according to still another embodiment; and

FIG. 14 is a further enlarged sectional view similar to FIG. 5.

### DETAILED DESCRIPTION OF THE INVENTION

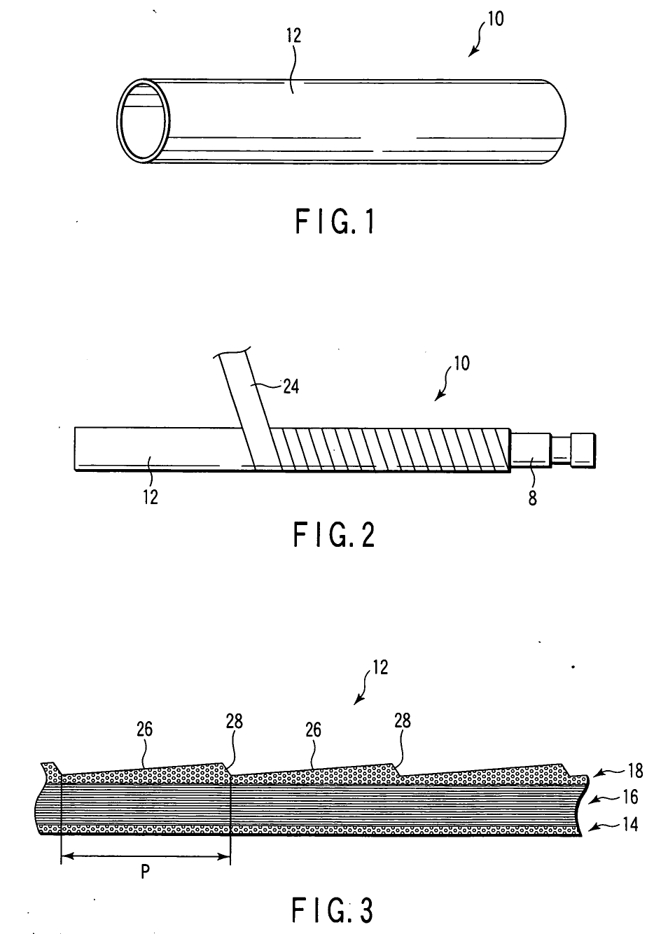

FIG. 1 to FIG. 8 show a tubular member 10 according to a preferred embodiment of the present invention.

As shown in FIG. 1, this tubular member 10 is formed for use as, for example, a fishing rod, and has a main body 12 with a hollow thin structure. This main body 12 is formed by winding, around a core metal 8 shown in FIG. 2, pieces of fiber reinforced prepregs (simply referred to as a prepreg in the following description) in which reinforcing fibers are impregnated with a synthetic resin. In such a prepreg, for example, carbon fibers, glass fibers or aramid fibers in which a fiber diameter is about 5 to 7 μm are preferably used as the reinforcing fibers. The resin with which the fibers are impregnated is preferably a thermosetting resin such as an epoxy resin, a polyester resin or a phenolic resin, into which a thermoplastic resin such as polyamide may be mixed.

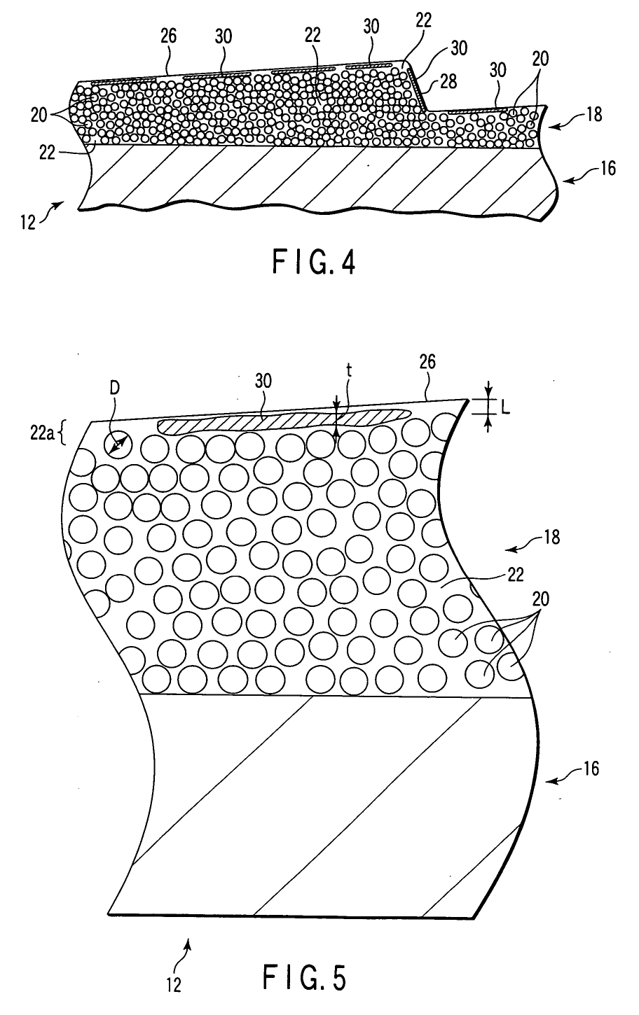

In the present embodiment, the main body 12 is formed into a triple-layer structure having an inner layer 14, an intermediate layer 16 and an outer layer 18 as shown in FIG. 3. The reinforcing fibers of the prepreg are drawn and aligned in a circumferential direction in the inner layer 14 and the outer layer 18, and in an axial longitudinal direction in the intermediate layer 16. In FIG. 4, there are shown such reinforcing fibers 20 in the outer layer 18, and a resin 22 with which the reinforcing fibers 20 are impregnated or mixed. Concerning the prepreg forming this outer layer 18, the impregnation amount of the resin in the prepreg forming an outermost layer thereof, that is, an outer surface of the main body 12 is set in a range of 20 wt % to 38 wt %, such that the weight reduction of this main body 12 can be promoted.

It is to be noted that the main body 12 is not limited to the triple-layer structure, and the prepreg may be wound on a structure having a proper number of stacked layers to form the main body 12, or each of the inner layer 14, the intermediate layer 16 and the outer layer 18 may be formed by a plurality of prepregs. Moreover, the reinforcing fibers can be formed to be drawn and aligned in a deflected direction which is inclined at a proper angle to the axial longitudinal direction, and the prepregs having different impregnated resins may be stacked as long as they can be suitably bonded to each other. Further, without limiting to the hollow structure as shown, a solid structure which can be greatly bent can be formed.

As shown in FIG. 2, a fastening tape 24 is wound on an outer peripheral portion of the main body 12 formed by stacking the prepregs in a peripheral portion of the core metal 8 as described above, and the main body 12 is pressured onto the core metal 8 by the fastening force of this fastening tape 24. In order to uniformly pressure the entire outer surface of the main body 12 with a required pressure, the fastening tape 24 is preferably helically wound with a pitch p of about 1.5 to 2 mm (FIG. 3) and an overlap of a predetermined width. The fastening tape 24 helically wound as mentioned above is made of, for example, a polypropylene resin, a polyethylene terephthalate resin or a combination of these resins having a thickness of about 10 to 35 μm and a width of about 5 to 20 mm in a one-layer, two-layer or sandwich structure, and the fastening tape 24 is preferably formed to have sufficient strength to pressure the outer surface of the main body 12 with a required fastening force.

FIG. 3 and FIG. 4 show a situation where such a fastening tape 24 is removed together with the core metal 8 after the main body 12 wound with the fastening tape 24 has been cured at a required temperature for a predetermined time and hardened. On the outer surface of the main body 12, there are formed or shaped a gently sloped surface 26 produced by a flat inner surface of the fastening tape 24, and a step 28 produced by a side edge portion of the fastening tape 24. The step 28 is formed between the outer surface of the fastening tape 24 wound earlier and the inner surface of the fastening tape wound to overlap the side edge portion thereof, and the step 28 helically extends on the outer surface of the outer layer 18.

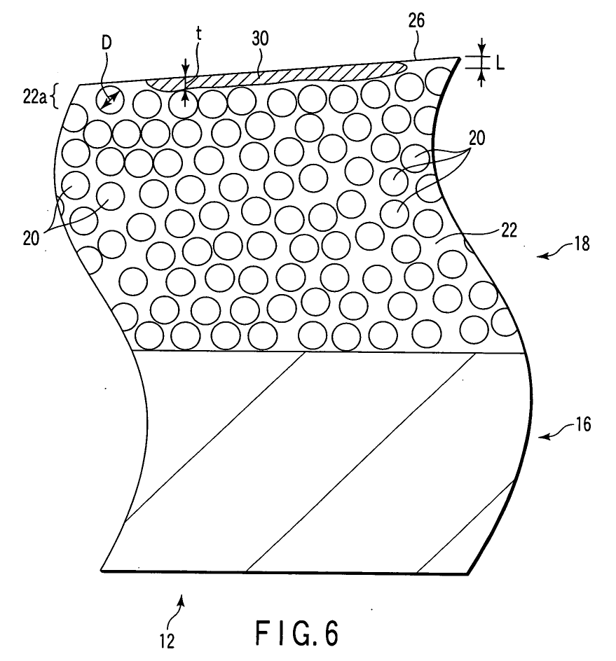

As shown in FIG. 5 and FIG. 6 in a further enlarged manner, a resin layer 22a in which the reinforcing fibers 20 are not arranged is formed on a surface side of the outer layer 18, and thin plate shaped decorative particles 30 are embedded in this resin layer 22a.

Such decorative particles 30 can be embedded in various methods in the outer surface side resin of the prepreg forming the outer layer 18 of the main body 12, especially the prepreg forming the resin layer 22a disposed on an outermost side. For example, it is possible to employ a method wherein the decorative particles 30 are blown to the outer surface side resin of the main body 12 by, for example, a spray, and then volatile components therein are removed so that the decorative particles 30 alone remain. The main body 12 formed by the uncured prepreg to which surface the decorative particles 30 are attached as described above is pressed onto, for example, a mat made of a fluorine material (not shown) in a rotated state or wound with a tape to apply external pressure on the main body 12, such that the decorative particles 30 can be completely embedded into the resin layer 22a. When the main body 12 is pressed onto the mat made of the fluorine material, extra decorative particles 30 can be removed from the decorative particles 30 overlapping each other. When the above-mentioned tape is wound to apply external force, the tape is removed after the decorative particles 30 have been embedded, such that the excess particles 30 can be removed from the main body 12.

A proper method can be applied to embed the decorative particles 30 into the resin layer 22a, and the decorative particles 30 are preferably spread on the resin layer 22a in a manner to maintain a highly viscous state of the prepreg before the wound prepreg is finally heated and hardened. This suppresses the movement of the decorative particles 30 in the uncured resin layer 22a, and the final heating process for hardening can be carried out in this state.

In each case, an average thickness L of the resin layer 22a made of the surface side resin of the fiber reinforced prepreg on the outermost side is formed to be smaller than an average diameter D of the reinforcing fibers 20 of this prepreg on the outermost side, and a thickness t of the decorative particles 30 is formed to be equal to or less than the average thickness L of the resin layer 22a. Here, the average thickness L of the resin layer 22a is an average value of distances between the reinforcing fibers 20 located on the outermost surface side and an outer surface of the resin layer 22a after the main body 12 is hardened, and the average thickness t of the decorative particles 30 is an average value of the thicknesses of both end portions and of a central portion along a direction in which a diametral dimension of the decorative particles 30 is greater. This resin layer 22a can have an average thickness L of 4 μm to 6 μm, and this is an extremely small thickness as compared with a case where an ordinary paint is applied to the surface of the resin layer 22a, and moreover, the decorative particles 30 therein make it possible to obtain decoration effects equivalent to those in the case where the paint is applied. Further, the decorative particles 30 can be formed to have an average thickness t of 0.05 μm to 1 μm, and when formed in such a range, the decorative particles 30 easily break into the outer surface side resin of the prepreg forming the resin layer 22a, so that the decorative particles 30 can have a good property of closely contacting the resin layer 22a.

The outer surface of the resin layer 22a embedded with such decorative particles 30 is completely buried inside together with the reinforcing fibers 20 with no protruding of the decorative particles 30 as shown in FIG. 5, and the smoothly curved sloped surface 26 can be formed. In this case, even when the decorative particles 30 contact the reinforcing fibers 20 to cause imperfect close contact or adhesion, it is possible to prevent the decorative particles 30 from dropping from the resin layer 22a. All the decorative particles 30 are covered with the resin of the resin layer 22a, and the resin forming the resin layer 22a is interposed in a layer shape between the decorative particles 30 and the sloped surface 26. Thus, the decorative particles 30 do not easily drop from the main body 12 and the resin layer 22a, resulting in a good abrasion resisting property. Moreover, the fading or deterioration of the decorative particles 30 is restrained, which enables the decoration effects to be maintained for a long time.

Furthermore, for example, when the average thickness t of the decorative particles 30 is substantially equal to the average thickness L of the resin layer 22a, the decorative particles 30 may be partly exposed to the outside to form part of the sloped surface 26 of the resin layer 22a, as shown in FIG. 6. Thus, when the decorative particles 30 are partly exposed directly to the outside, the original color and brilliant impression of the decorative particles 30 are directly exteriorly shown, thereby permitting an increase in the decoration effects. Even when the decorative particles 30 are completely embedded in the resin layer 22a or when the decorative particles 30 are partly exposed in the outer surface, the outer surface of the resin layer 22a is formed by the flat and smooth surface smoothly curved by the external force as described above, such that the tubular member 10 is reduced in weight, and the formed color and brilliant impression of the decorative particles 30 can be emphasized while unevenness is hardly formed in the outer surface.

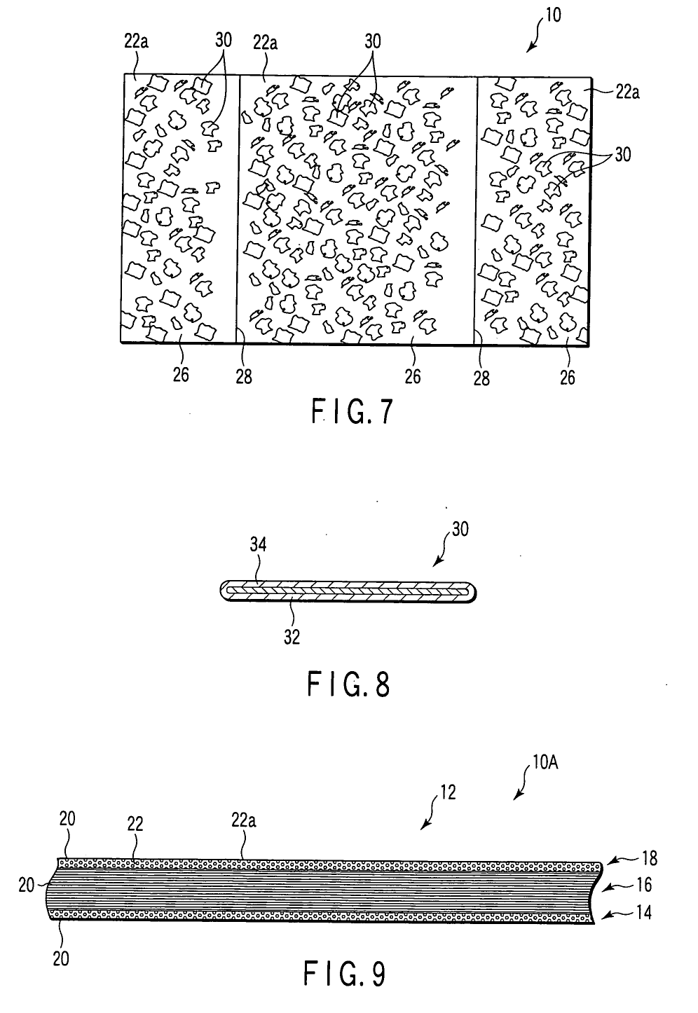

FIG. 7 shows the appearance of the tubular member 10 formed in such a manner. In the present embodiment, the decorative particles 30 having various shapes are combined, and the use of such decorative particles 30 of many kinds makes it possible to emphasize the brilliant shining of the tubular member 10 produced by the respective decorative particles 30 and form a varied appearance. As shown, the density of the decorative particles 30 may be low in a proper part such as a part in the vicinity of the step 28 or the density of the decorative particles 30 may be partly changed throughout the outer surface of the tubular member 10 in order to make a difference of appearance in design.

As shown in FIG. 8, such a decorative particle 30 can be formed by covering, with a cover layer 34, a core member 32 made of a thin sliced metal such as an aluminum flake or a particle made of a natural mineral such as mica. For example, a resin, magnesium fluoride, titanium oxide, chromium oxide or ceramics can be used for the cover layer 34. The decorative particles 30 can be formed of not only particles of a metal or the like having a brilliant color but also transparent particles. When the decorative particles 30 are formed of the transparent particles, it is possible to use transparent metal thin film chips, thin film resin chips of glass flakes with a multilayer structure, or hologram chips. Moreover, when thin sliced particles in which a metal is deposited onto a resin sheet, or brilliant particles which generate coherent light are used as the decorative particles 30, the gorgeous appearance of the main body 12 can be emphasized. The outer shape of such decorative particles can be formed into any shape, and various foil shapes can be formed instead of, for example, a circular shape in order to improve effects of concealing the outer surface of the main body 12.

In the tubular member 10 formed as described above, the thin film or foil decorative particles 30 with various shapes are embedded into the resin layer 22a formed on the outer surface side by the prepreg of the main body 12, and the average thickness L of the resin layer 22a is formed to be smaller than the average diameter D of the reinforcing fibers 20 of the fiber reinforced prepreg on the outermost side, and moreover, the average thickness t of the decorative particles 30 is formed to be less than the average thickness L of the resin layer 22a. Thus, the decorative particles 30 are reliably held into the outer surface side resin 22 of the fiber reinforced prepreg located on the outermost side of the main body and are thus prevented from dropping. Moreover, the decorative particles 30 are held into the extremely thin resin layer 22a on the outer surface side of the fiber reinforced prepreg, so that it is possible to form the tubular member 10 with extremely light weight and high decoration effects.

It is to be noted that the prepreg forming the outer layer 18 of the main body 12 may be semitransparent instead of being transparent as long as the decorative particles 30 is made visible from the outside by the resin 22.

FIG. 9 to FIG. 12 show a tubular member 10A according to another embodiment. It is to be noted that various embodiments or modifications described below are basically similar to the embodiment described above, and therefore, like numerals are given to like members.

In the tubular member 10A of the present embodiment, a main body 12 has a triple-layer structure including an inner layer 14, an intermediate layer 16 and an outer layer 18, as in the embodiment described above. It is to be noted that the main body 12 is not limited to the triple-layer structure, and may have a structure with the proper number of stacked layers. In the present embodiment again, reinforcing fibers 20 are drawn and aligned in a circumferential direction in the inner layer 14 and the outer layer 18, and in a longitudinal axial direction of the main body 12 in the intermediate layer 16. Further, the impregnation amount of the resin in the prepreg forming the outer layer 18 which is an outermost layer is less than 25 wt %.

In this main body 12, a solvent into which the decorative particles 30 similar to those described above (see FIG. 8) are mixed are blown onto the outer surface of the main body 12, and the solvent is vaporized, such that the decorative particles 30 are attached to the outer surface. In the present embodiment, a sliced metal particle such as an aluminum flake or a particle made of a natural mineral such as mica is used as a core member 32 of the decorative particles 30, and, for example, an acrylic resin, a polyester resin or an epoxy resin is used as a cover layer 34. Such decorative particles 30 can be obtained by forming, for example, a metal layer between resin layers and crushing them by, for example, sonication. Then, when the decorative particles 30 are mixed into the solvent, the cover layer 34 partly melts to provide viscosity, and when the solvent in which the decorative particles 30 are mixed is blown onto the outer surface of the main body 12, the decorative particles 30 can be attached to the outer surface of the resin layer 22a with good cohesion.

After the decorative particles 30 are attached to the outer surface of the resin layer 22a, the outer peripheral portion of the main body 12 is covered with a cylindrical elastic tube (not shown) as a cover member, and the main body 12 is heated at a predetermined temperature for a predetermined time while external pressure is being applied thereto, and then the main body 12 is cured and hardened while the main body 12 is being tightly pressured by the thermal shrinkage of the elastic tube. After the hardening process, a core metal and the elastic tube are removed from the main body 12. As a result, the outer surface of the main body 12 is formed into a smooth cylindrical surface. Here, the elastic tube may be made of, for example, ethylene propylene, a silicone rubber and a fluorine resin.

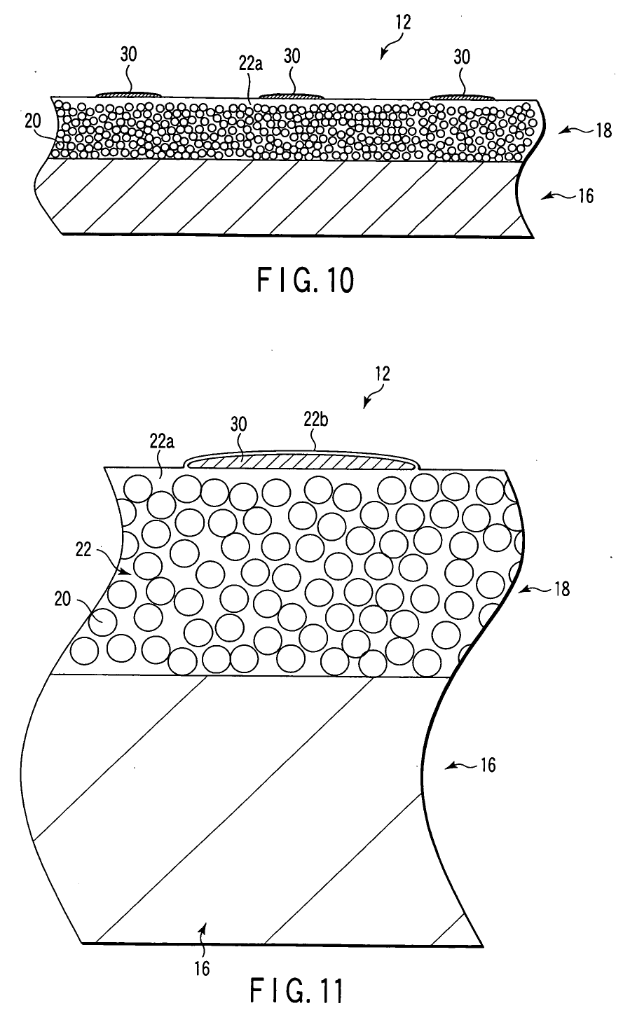

As shown in FIG. 10, the resin layer 22a is exposed between the decorative particles 30 in the outer surface of the main body 12. Further, as shown in FIG. 11 in an enlarged manner, the decorative particles 30 are not embedded in the resin layer 22a, and protrude outward from the resin layer 22a. A resin film 22b is formed along the outer surface of the decorative particles 30. The thickness of the resin film 22b is smaller than the thickness of the decorative particles 30. It is to be noted that the resin film 22b is preferably formed along the entire outer surface of the decorative particles 30, but a decorative area by the decorative particles 30 may be formed on one or both of upper and lower sides along an axial direction when the cylindrical outer surface of the main body 12 is developed in a plane. Moreover, the thickness of the resin film 22b and the decorative particles 30 is an average value of the thicknesses of both end portions and of a central portion along a direction in which a diametral dimension of the decorative particles 30 is greater.

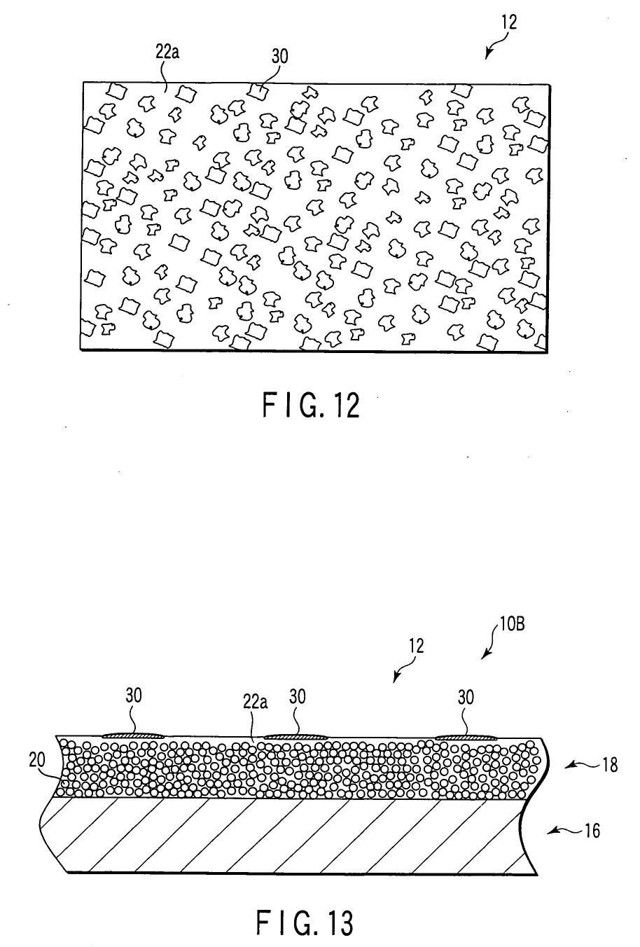

As shown in FIG. 12, the decorative particles 30 are arranged in the outer surface of the main body 12 to occupy 5% to 50% of the area of the outer surface of the main body 12. Moreover, the maximum width of the decorative particles 30 in the outer surface of the main body 12 is preferably 200 μm or more and less than 800 μm.

Therefore, the tubular member 10A of the present embodiment has the following effects. In the tubular member 10A of the present embodiment, the decorative particles 30 are arranged in the outer surface of the resin layer 22a, the resin film 22b having a thickness smaller than the thickness of the decorative particles 30 is formed on the outer surface of the decorative particles 30, and moreover, the resin layer 22a is exposed between the decorative particles 30, such that the tubular member has lighter weight and high decoration effects. Further, since the resin film 22b is formed on the outer surface of the decorative particles 30, the close contacting property of the decorative particles 30 is improved.

Furthermore, the decorative particles 30 protrude from the outer surface of the resin layer 22a on the outer surface side, and the resin film 22b is formed to be in close contact with the outer surface of the decorative particles 30 along the outer surface of the decorative particles 30. Thus, abrasion resisting properties are high, the decoration effects which are not subject to fading are achieved, and the closely contacted adhering property of the decorative particles 30 is further improved. Moreover, favorable operability is obtained with, for example, slip prevention, and there is also an effect of preventing the sticking of a line.

Moreover, the decorative particles 30 are arranged in the outer surface of the main body 12 to occupy 5% to 50% of the area of the outer surface of the main body 12. That is, the area occupied by the decorative particles 30 is relatively small, and a further reduction is therefore possible in the weight of the main body 12. Further, the decoration can be varied, and partial decoration can achieve a decorated appearance as a one-point accent.

Still further, the close contacting or adhering property of the decorative particles 30 is reduced with a reduction in the impregnation amount of the resin in the prepreg 16 forming the outermost layer of the main body 12, but in the configuration as described above in which the close contacting property of the decorative particles 30 is high, the impregnation amount of the resin can be reduced while the sufficient close contacting property is maintained. In the present embodiment, the impregnation amount of the resin in the prepreg 16 forming the outermost layer of the main body 12 is less than 25 wt %, so that the weight of the main body 12 is sufficiently reduced while the sufficient close contacting property of the decorative particles 30 is maintained.

It is to be noted that the cover layer 34 of the decorative particles 30 partly melts in the solvent to provide viscosity, so that the decorative particles 30 can be attached to the outer surface of the resin layer 22a on the outer surface side with good cohesion. Thus, even when the impregnation amount of the resin in the prepreg 16 forming the outermost layer of the main body 12 is small as in the present embodiment, the decorative particles 30 do not easily come off. Further, even if the reinforcing fibers 20 are exposed in the outer surface of the resin layer 22a, the property of close contact between the decorative particles 30 and the reinforcing fibers 20 can be maintained, and the decorative particles 30 do not easily come off. Moreover, the decorative particles 30 may be attached to the outer surface of the main body 12 after the molding and hardening of the main body 12, and the tape is wound around the outer peripheral portion of the main body 12, and then the main body 12 may be burnt and hardened. Further, before the solvent into which the decorative particles 30 are mixed is blown onto the outer surface of the main body 12, the main body 12 may be heated into a semi-hardened state. In this case, if the hardness of the outer surface side resin layer 22a is higher than the hardness of the cover layer 34 of the decorative particles 30 in the outer surface of the main body 12, the decorative particles 30 are not easily buried and not easily moved, so that the decorative particles 30 can be attached with better cohesion.

In addition, the decorative particles 30 that are relatively large are inferior in the property of closely contacting the resin layer 22a, but in the configuration as described above in which the close contacting property of the decorative particles 30 is enhanced by the resin film 22b, the relatively large decorative particles 30 can be used while maintaining a sufficient close contacting property, so that good decoration effects can be obtained. In the present embodiment, the maximum width of the decorative particles 30 is 200 μm or more and less than 800 μm, and good decoration effects are achieved while maintaining a sufficient close contacting property. Moreover, the use of a large amount of the relatively large decorative particles 30 may impair the effects of weight reduction of the main body 12. However, in the present embodiment, the decorative particles 30 are arranged to occupy 5% to 50% of the area of the outer surface of the main body 12, and the sufficient close contacting property and good decoration effects are achieved without impairing the effects of weight reduction of the main body 12.

It is to be noted that instead of pressuring such a main body 12 of the tubular member 10A by the elastic tube, the fastening or shaping tape 24 as shown in FIG. 2 may be wound around the outer peripheral portion of the main body 12, and the main body 12 may be pressured on the core metal 8 by the fastening force of the tape 24. Consequently, as shown in FIG. 3, there are formed, on the outer peripheral portion of the main body 12, the gently sloped surface 26 produced by the flat inner surface of the fastening tape, and the step 28 produced by the side edge portion of the fastening tape. As in the embodiment described above, the decorative particles 30 are arranged to occupy 5% to 50% of the area of the outer surface of the main body 12, and the maximum width of the decorative particles 30 in the outer surface of the main body 12 is 200 μm or more and less than 800 μm.

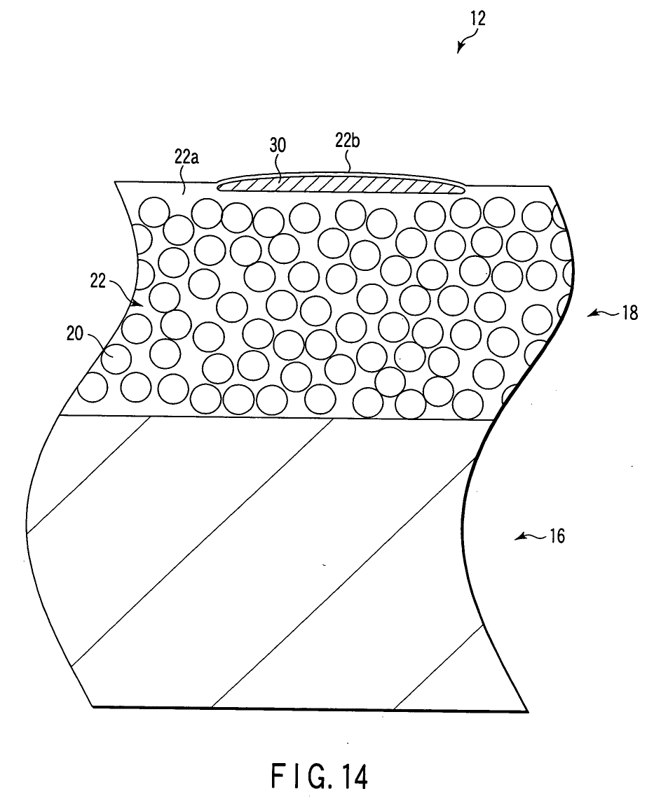

FIG. 13 to FIG. 14 show a tubular member 10B according to still another embodiment of the present invention.

In the present embodiment, after the decorative particles 30 are attached to the outer surface of the resin layer 22a on the outer surface side, external pressure is applied thereto to partly embed the decorative particles 30 into the resin layer 22a. For example, the outer surface of the main body 12 is pressed onto the mat made of a fluorine material in a rotated state or a tape is wound around the outer surface of the main body 12, such that the decorative particles 30 can be partly embedded.

As shown in FIG. 14, in the present embodiment, the decorative particles 30 are partly embedded in the outer surface side resin layer 22a, and the decorative particles 30 and the resin film 22b at least partly protrude from the outer surface side resin layer 22a. In addition, as in the embodiment described above, the resin film 22b is formed along the outer surface of the decorative particles 30, and the thickness of the resin film 22b is smaller than the thickness of the decorative particles 30.

Therefore, the tubular member of the present embodiment has the following effects. In the present embodiment, the decorative particles 30 are partly embedded in the outer surface side resin layer 22a, and the decorative particles 30 and the resin film 22b protrude from the outer surface of the outer surface side resin layer 22a. Thus, the decorative particles 30 do not easily come off, the abrasion resisting properties are high, the decoration effects which are not subject to fading are achieved.

While the present invention has been described and explained in connection with the particular embodiments, it is obvious to those skilled in the art that various modifications or alterations can be made within the principle of the present invention described above. For example, the main body 12 in the embodiment shown in FIG. 1 to FIG. 8 can be pressured by use of the elastic tube instead of the fastening tape 24 described above.

What is claimed is:

1. A tubular member comprising a tubular main body formed by being wound with at least a piece of fiber reinforced prepreg, the fiber reinforced prepreg being formed by impregnating a large number of reinforcing fibers having an average diameter with a synthetic resin, the main body having an outer surface side resin layer made of the synthetic resin, wherein
the outer surface side resin layer has an average thickness;
the outer surface side resin layer further includes a large number of decorative particles embedded therein;
the large number of decorative particles have an average thickness;
the average thickness of the outer surface side resin layer is smaller than the average diameter of the reinforcing fibers; and
the average thickness of the decorative particles is smaller than the average thickness of the outer surface side resin layer.

2. The tubular member according to claim 1, wherein the decorative particles are covered with the outer surface side resin layer.

3. The tubular member according to claim 1, wherein the decorative particles are partly exposed to the outside from the outer surface side resin layer.

4. The tubular member according to claim 1, wherein the average thickness of the outer surface side resin ranges from 4 μm to 6 μm.

5. The tubular member according to claim 1, wherein the thickness of the decorative particles ranges from 0.05 μm to 1 μm.

6. The tubular member according to claim 1, wherein the fiber reinforced prepreg wound on an outermost side of the main body has the reinforcing fibers thereof completely covered with the outer surface side resin.

7. The tubular member according to claim 1, wherein the main body is formed by being wound with multiple pieces of fiber reinforced prepregs, and the impregnation amount of the resin in the fiber reinforced prepreg wound on the outermost side ranges from 20 wt % to 38 wt %.

8. The tubular member according to claim 1, wherein the main body has a flat outer surface.

9. A tubular member comprising:
a tubular main body formed by being wound with at least one fiber reinforced prepreg, the fiber reinforced prepreg being formed by a large number of reinforcing fibers having an average diameter impregnated with a synthetic resin, the main body having an outer surface side resin layer made of the synthetic resin;
a large number of decorative particles disposed in the outer surface side resin layer, each of the decorative particles having a thickness and an outer surface which is not covered with the outer surface side resin layer; and
a resin film formed on the outer surface of the decorative particles and having a thickness smaller than the thickness of the decorative particles,
wherein the outer surface side resin layer is exposed between the adjacent decorative particles.

10. The tubular member according to claim 9, wherein the decorative particles have an outer surface protruding from the outer surface side resin layer, and
the resin film is formed along the outer surface protruding from the outer surface side resin layer of the decorative particles.

11. The tubular member according to claim 9, wherein the decorative particles are at least partly embedded in the outer surface side resin layer, and
the decorative particles and the resin film at least partly protrude from the outer surface side resin layer.

12. The tubular member according to claim 9, wherein in the outer surface of the main body, the decorative particles occupy 5% to 50% of the area of the outer surface of the main body.

13. The tubular member according to claim 9, wherein the fiber reinforced prepreg forming an outermost layer of the main body has a resin impregnation amount of less than 25 wt %.

14. The tubular member according to claim 9, wherein the maximum width of the decorative particles in the outer surface of the main body is 200 μm or more and less than 800 μm.

15. A method of manufacturing a tubular member, comprising the steps of:
winding, around a core member, a fiber reinforced prepreg in which reinforcing fibers are impregnated with a synthetic resin, to form a tubular main body;
mixing decorative particles covered with a resin into a solvent, blowing the solvent onto an outer surface of the main body, and vaporizing the solvent in order to attach the decorative particles to the outer surface of the main body;
covering the outer surface of the main body with a cover member to cure the main body; and
removing the core member and the cover member from the main body.
